(19) United States
(12) Patent Application Publication
(10) Pub. No.: US 2026/0337487 A1
(43) Pub. Date: Oct. 29, 2026

(54) REINFORCEMENT SLURRY FOR DESERTIFIED SOIL, PREPARATION METHOD THEREFOR AND APPLICATION THEREOF

(71) Applicant: Tianfu Yongxing Laboratory, Chengdu (CN)

(72) Inventors: Yinhao Liao, Chengdu (CN); Xiangjun Pei, Chengdu (CN); Lihong Zhou, Chengdu (CN); Xiaolu Tang, Chengdu (CN); Shan Li, Chengdu (CN); Jingri Lv, Chengdu (CN); Hongchao Xi, Chengdu (CN)

(21) Appl. No.: 19/450,680

(22) Filed: Jan. 15, 2026

(30) Foreign Application Priority Data
Apr. 29, 2025 (CN) 202510552484.9

(51) Int. Cl. C09K 17/32; E02D 3/00

(52) U.S. Cl. CPC C09K 17/32; E02D 3/005; E02D 2300/0067

(57) ABSTRACT

A reinforcement slurry for desertified soil includes the following raw materials: 0.5 weight percent (wt. %) to 1 wt. % of xanthan gum, 0.05 wt. % to 0.2 wt. % of microcrystalline cellulose, 0.05 wt. % to 0.2 wt. % of chitosan, 0.2 wt. % to 0.5 wt. % of triethanolamine, 1 per mille (‰) to 5‰ volume by volume (v/v) of glycerol, and the balance of water. In the present disclosure, through the synergistic effect of natural bio-based materials, the compressive strength and shear strength of sandy soil are significantly improved while the environmental pollution problem caused by synthetic polymers is addressed. The present disclosure can not only fix sand and resist wind in a short term, but also promote the transformation of desertified land into a sustainable ecosystem, providing an environmentally friendly, efficient and low-cost solution for desertification control.

### CROSS-REFERENCE TO RELATED APPLICATION

This application claims priority of Chinese Patent Application No. 202510552484.9, filed on Apr. 29, 2025, the entire contents of which are incorporated herein by reference.

### TECHNICAL FIELD

The present disclosure relates to the technical field of desertified soil improvement, and in particular to a reinforcement slurry for desertified soil, a preparation method therefor and an application thereof.

### BACKGROUND

Desertified soil is easily eroded by wind because of its loose, barren and poor water and fertilizer retention ability, resulting in frequent sandstorms and declining land productivity.

Early windbreak and sand fixation mainly relied on physical barriers (such as grass squares and sand barriers) or single vegetation planting, but there are some problems such as high cost, difficult maintenance and poor ecological adaptability. For example, straw checkerboards are prone to aging and failure in extremely arid regions, while the planting of a single plant species may lead to a reduction in biodiversity. Therefore, new sandy soil improvement technologies based on materials science and ecological engineering (such as biological crust induction, soil adhesive, organic-inorganic composites) have gradually become research hotspots.

The disclosure patent with a publication number of CN103348838A provides a method for preparing modified sand, which is formed by dissolving water-soluble solid organic substances in water to form a cohesive and adhesive solution, which is mixed with sandy soil; after water evaporation, the water-soluble solid organic substances therein can bond sandy soil particles, and can redissolve in water when encountering water to form a cohesive and adhesive solution that adheres to sandy soil particles. The disclosure realizes the “soilification” of ordinary sandy soil, fundamentally changes the interaction relationship between sandy soil particles, and forms a granular pore structure with bonding force (cohesion); during use, the substances are not easy to lose due to their cohesive and adhesive properties; the modified sandy soil is endowed with the performance of stabilizing and storing water and nutrients like natural soil, can provide a solid growth condition for plants, and serves as an ideal measure for controlling sandy soil and deserts; and meanwhile, the modified sandy soil can also be used as a means of utilizing sand resources such as beaches and sandlands for plant cultivation.

The disclosure patent with a publication number of CN103348836A provides a method for controlling sandy land using modified sandy soil. The modified sandy soil is paved on the surface of the sandy land to be controlled, and the modified sandy soil is formed by dissolving water-soluble solid organic substances in water to form a cohesive and adhesive solution, which is then mixed with sandy soil; after water evaporation, the water-soluble solid organic substances therein can bond sandy soil particles, and can redissolve in water when encountering water to form a cohesive and adhesive solution that adheres to sandy soil particles, thereby realizing the “soilification” of ordinary sandy soil, fundamentally changing the interaction relationship between sandy soil particles, and forming a granular pore structure with bonding force (cohesion); after repeated evaporation and wetting, the substances are not easy to lose due to their cohesive and adhesive properties; and the modified sandy soil is endowed with the performance of stabilizing and storing water and nutrients like natural soil, can provide a solid condition for plant growth, and serves as an ideal measure for controlling deserts.

Although the related art mixes the sand and the solution to improve the performance of the sand and realize the treatment of the sand. However, the modified products used include polymers including polyvinyl alcohol, polyethylene oxide, polyethylene glycol, and sodium polyacrylate, which are easy to cause environmental pollution and are not conducive to ecological protection.

Therefore, it is necessary to provide a desertified soil improvement product without using polymers, aiming to improve desertified soil, enhance its wind erosion resistance on the premise of reducing environmental pollution risks, and achieve desertification reversal and ecological restoration.

### SUMMARY

In view of the above, the present disclosure provides a reinforcement slurry for desertified soil, a preparation method therefor and an application thereof. Through the synergistic action of natural bio-based materials (such as xanthan gum, chitosan and microcrystalline cellulose), the present disclosure remarkably improves the compressive strength and shear strength of sand while solving the environmental pollution problem of synthetic polymers. The present disclosure can not only fix sand and prevent wind in a short period of time, but also promote the transformation of desertified land to a sustainable ecosystem, thereby providing an environmentally friendly, efficient and low-cost solution for desertification control.

A first aspect of the present disclosure is to provide a reinforcement slurry for desertified soil, including the following raw materials:

0.5 weight percent (wt. %) to 1 wt. % of xanthan gum, 0.05 wt. % to 0.2 wt. % of microcrystalline cellulose, 0.05 wt. % to 0.2 wt. % of chitosan, 0.2 wt. % to 0.5 wt. % of triethanolamine, 1 per mille (‰) to 5‰ volume by volume (v/v) of glycerol, and the balance of water.

Preferably, a mass ratio of the microcrystalline cellulose to the xanthan gum is 1:(5-10); and more preferably, the mass ratio of the microcrystalline cellulose to the xanthan gum is 1:10.

Preferably, a mass ratio of the chitosan to the xanthan gum is 1:(5-10); and more preferably, the mass ratio of the chitosan to the xanthan gum is 1:10.

Preferably, the reinforcement slurry for desertified soil includes the following raw materials:
1 wt. % of xanthan gum, 0.1 wt. % of microcrystalline cellulose, 0.1 wt. % of chitosan, 0.5‰ (v/v) of triethanolamine, 5‰ (v/v) of glycerol, and the balance of water.

A second aspect of the present disclosure provides a preparation method for the reinforcement slurry for desertified soil, specifically including the steps of:
S1, dissolving xanthan gum in water, followed by heating and stirring for a period of time to obtain a solution A;
S2, sequentially adding triethanolamine and microcrystalline cellulose into the solution A, followed by heating and stirring for a period of time to obtain a solution B; and
S3, adding chitosan and glycerin into the solution B, followed by heating and stirring for a period of time; and cooling the mixed solution to obtain the reinforcement slurry for desertified soil.

Preferably, the heating temperature of S1 is 20 °C-60 °C, the stirring speed is 600-1200 rpm, and the stirring time is 2-4 h. More preferably, the heating temperature of S1 is 40 °C, the stirring speed is 1200 rpm, and the stirring time is 2 h.

Preferably, the heating temperature of S2 is 40 °C-70 °C, the stirring speed is 600-1200 rpm, and the stirring time is 0.5-3 h. More preferably, the heating temperature of S2 is 50 °C, the stirring speed is 1200 rpm, and the stirring time is 0.5 h.

Preferably, the heating temperature of S3 is 50 °C, the stirring speed is 300-800 rpm, and the stirring time is 0.5-3 h. More preferably, the heating temperature of S3 is 50 °C, the stirring speed is 500 rpm, and the stirring time is 0.5 h.

A third aspect of the present disclosure provides an application of the reinforcement slurry for desertified soil for reinforcing desertified soil, the reinforcement slurry for desertified soil being the reinforcement slurry for desertified soil according to the above technical solutions.

Preferably, the application of the reinforcement slurry for desertified soil includes the method of:
mixing the reinforcement slurry for desertified soil and desertified soil evenly to obtain reinforcement desertified soil and realize desertified soil treatment.

Preferably, a volume ratio of the reinforcement slurry for desertified soil to the desertified soil is 1:(5-8).

Compared with the related art, the present disclosure has the following advantages.

In the present disclosure, the desertified soil reinforcement slurry is prepared by using natural bio-based materials including xanthan gum (a microbial polysaccharide), chitosan (a chitin derivative), and microcrystalline cellulose (a plant fiber extract). This preparation method ensures the product possesses biodegradability, prevents the generation of persistent pollution after decomposition in the environment, and achieves higher ecological compatibility.

The polymer binders in the related art mainly form cohesion through physical wrapping of sand particles, but the polymer binders are prone to aging and failure when subjected to long-term effects such as ultraviolet radiation and wet-dry cycles. In the present disclosure, the network structure of xanthan gum combined with the cationic properties of chitosan can bind to the negative charges on the surface of sand particles to form stable chemical bonds; and microcrystalline cellulose enhances inter-particle crosslinking through hydrogen bonds. The synergistic effect of the three significantly improves the compressive strength and shear strength of sandy soil, making the sandy soil more suitable for complex stress environments.

In the present disclosure, the water absorption of xanthan gum and chitosan can regulate the humidity of sandy soil. During dry-wet cycles, the bonding effect is maintained through repeated dissolution and solidification, which extends the sand fixation duration, improves the water retention capacity of sandy soil, and reduces water evaporation.

### BRIEF DESCRIPTION OF THE DRAWINGS

The present disclosure will be further described below with reference to the description of the drawings.

FIG. 1A shows a physical image of a control group sample in Test Example 1.

FIG. 1B shows a physical image of an experimental group sample in Test Example 1.

FIG. 2 is a test result of compressive strength of a sample of Test Example 1.

FIG. 3A is a shear stress-time curve of Example 1 under a vertical stress of 50 kPa.

FIG. 3B is a shear stress-time curve of Example 1 under a vertical stress of 100 kPa.

FIG. 3C is a shear stress-time curve of Example 1 under a vertical stress of 150 kPa.

FIG. 3D is a shear stress-time curve of Example 1 under a vertical stress of 200 kPa.

FIG. 4A is a shear stress-time curve of Comparative Example 1 under a vertical stress of 50 kPa.

FIG. 4B is a shear stress-time curve of Comparative Example 1 under a vertical stress of 100 kPa.

FIG. 4C is a shear stress-time curve of Comparative Example 1 under a vertical stress of

150 kPa.

FIG. 4D is a shear stress-time curve of Comparative Example 1 under a vertical stress of 200 kPa.

### DETAILED DESCRIPTION

Technical solutions of the present disclosure will be described clearly and completely in the following with reference to the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

To further illustrate the present disclosure, the following examples will be described in detail. The raw materials used in the following examples of the present disclosure are all commercially available.

A first aspect of the present disclosure is to provide a reinforcement slurry for desertified soil, including the following raw materials:
0.5 wt. % to 1 wt. % of xanthan gum, 0.05 wt. % to 0.2 wt. % of microcrystalline cellulose, 0.05 wt. % to 0.2 wt. % of chitosan, 0.2 wt. % to 0.5 wt. % of triethanolamine, 1‰ to 5‰ (v/v) of glycerol, and the balance of water.

In some specific examples of the present disclosure, a mass ratio of the microcrystalline cellulose to the xanthan gum is 1:(5-10), and preferably 1:10. A mass ratio of the chitosan to the xanthan gum is 1:(5-10), and preferably 1:10.

In some preferred examples of the present disclosure, the reinforcement slurry for desertified soil includes the following raw materials:
1 wt. % of xanthan gum, 0.1 wt. % of microcrystalline cellulose, 0.1 wt. % of chitosan, 0.5‰ (v/v) of triethanolamine, 5‰ (v/v) of glycerol, and the balance of water.

A second aspect of the present disclosure provides a preparation method for the reinforcement slurry for desertified soil, specifically including the steps of:

In S1, xanthan gum was dissolved in water, heated and stirred for a period of time to obtain a solution A.

In S2, triethanolamine and microcrystalline cellulose were sequentially added into the solution A, heated and stirred for a period of time to obtain a solution B.

In this step, the triethanolamine can activate the microcrystalline cellulose, thereby promoting the mixed cross-linking of the microcrystalline cellulose and the xanthan gum to form an interpenetrating network.

In S3, chitosan and glycerin were added into the solution B, heated and stirred for a period of time, and cooled to obtain the reinforcement slurry for desertified soil.

In this step, the glycerol can regulate the fluidity of the slurry, and the chitosan can reinforce the interpenetrating network formed by the xanthan gum and the microcrystalline cellulose.

In some specific examples of the present disclosure, the heating temperature in S1 is 20 °C-60 °C, preferably 40 °C; the stirring speed is 600-1200 rpm, preferably 1200 rpm; and the stirring time is 2-4 h. The heating temperature in S2 is 40 °C-70 °C, preferably 50 °C; the stirring speed is 600-1200 rpm, preferably 1200 rpm; and the stirring time is 0.5-3 h. The heating temperature in S3 is 50 °C; the stirring speed is 300-800 rpm, preferably 500 rpm; and the stirring time is 0.5-3 h.

A third aspect of the present disclosure provides an application of the reinforcement slurry for desertified soil for reinforcing desertified soil, the reinforcement slurry for desertified soil being the reinforcement slurry for desertified soil according to the above technical solutions.

In some specific examples of the present disclosure, the application method of the reinforcement slurry for desertified soil is as follows.

The reinforcement slurry for desertified soil and desertified soil were mixed evenly to obtain the reinforced desertified soil and realize the treatment of desertified soil.

A volume ratio of the reinforcement slurry for desertified soil to the desertified soil is 1:(5-8).

Hereinafter, the technical solutions in the examples of the present disclosure will be clearly and completely described. Obviously, the described examples are only some examples of the present disclosure, but not all examples. Based on the examples in the present disclosure, other examples obtained by those skilled in the art without creative work fall within the scope of protection of the present disclosure. In the following examples, all raw materials are commercially available.

All tests were repeated 3 times unless otherwise specified and results were expressed as mean values.

Example 1 A reinforcement slurry for desertified soil includes the following raw materials:
1 wt. % of xanthan gum, 0.1 wt. % of microcrystalline cellulose, 0.1 wt. % of chitosan, 0.5‰ (v/v) of triethanolamine, 5‰ (v/v) of glycerol, and the balance of water.

A preparation method for the reinforcement slurry for desertified soil includes the following steps.

In S1, raw materials were weighed in proportion, and xanthan gum was dissolved in water, heated at 40 °C and stirred at a speed of 1200 rpm for 2 h to obtain a solution A.

In S2, triethanolamine and microcrystalline cellulose were sequentially added to the solution A, heated at 50 °C and stirred at a speed of 1200 rpm for 0.5 h to obtain a solution B.

In S3, chitosan and glycerin were added to the solution B, heated at 50 °C and stirred at a speed of 500 rpm for 0.5 h, and cooled to obtain the reinforcement slurry for desertified soil.

### Test Example 1

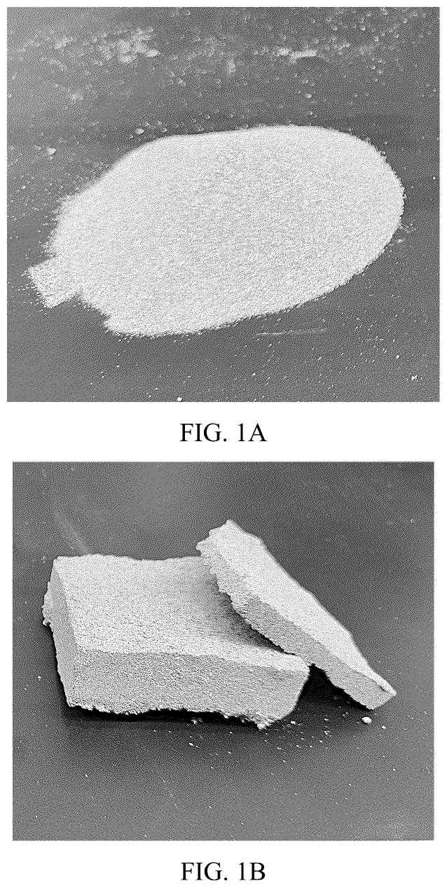

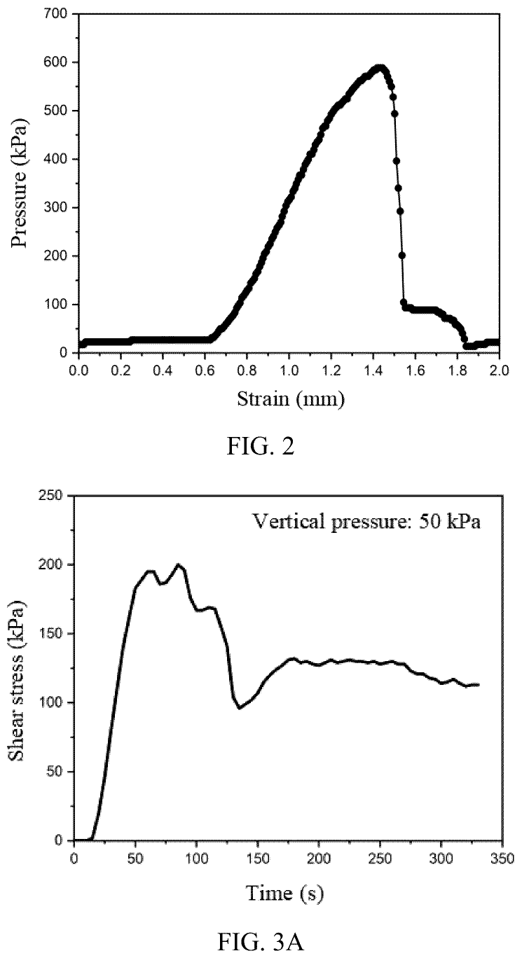

The reinforcement slurry for desertified soil prepared in Example 1 and the desertified soil were mixed evenly at a volume ratio of 1:8 to serve as an experimental group, and an equal amount of pure water was used to replace the reinforcement slurry for desertified soil to serve as a control group. Samples of the experimental group and the control group were placed in a 70 cm×70 cm×70 cm mold, compacted under the same conditions, taken out, air-dried at room temperature for 7 days, and the compressive strength of the soil blocks was tested on an unconfined compressive strength tester. The test results are shown in FIGS. 1A, 1B, and 2.

The results showed that the samples of the control group failed to form stable soil blocks after air-drying and had no bearing capacity, while the reinforcement desertified soil samples of the experimental group could withstand a pressure of 588.5 kPa.

### Comparative Example 1

The difference from Example 1 was that microcrystalline cellulose and chitosan were not used.

The cohesive force of the sandy soil reinforced by the soil reinforcement slurry in Example 1 was 170.5 kPa, with an internal friction angle of 25.3°; the cohesive force of the sandy soil reinforced by the soil reinforcement slurry in Comparative Example 1 was 20.0 kPa, with an internal friction angle of 37.7°.

It can be seen that in the soil reinforcement slurry of the present disclosure, although dosages of microcrystalline cellulose and chitosan are very small, the microcrystalline cellulose and chitosan exert an important influence on improving the sand reinforcement effect.

### Comparative Example 2

The difference from Example 1 was that triethanolamine was not used.

### Comparative Example 3

The difference from Example 1 was that glycerol was not used.

### Comparative Example 4

The difference from Example 1 was that the microcrystalline cellulose was replaced with an equivalent amount of ordinary cellulose.

### Comparative Example 5

The differences from Example 1 were that:
(1) a mass ratio of microcrystalline cellulose to xanthan gum was 1:1; and
(2) a mass ratio of microcrystalline cellulose to xanthan gum was 1:15.

### Comparative Example 6

The differences from Example 1 were that:
(1) a mass ratio of chitosan to xanthan gum was 1:1; and
(2) a mass ratio of chitosan to xanthan gum was 1:15.

### Test Example 2

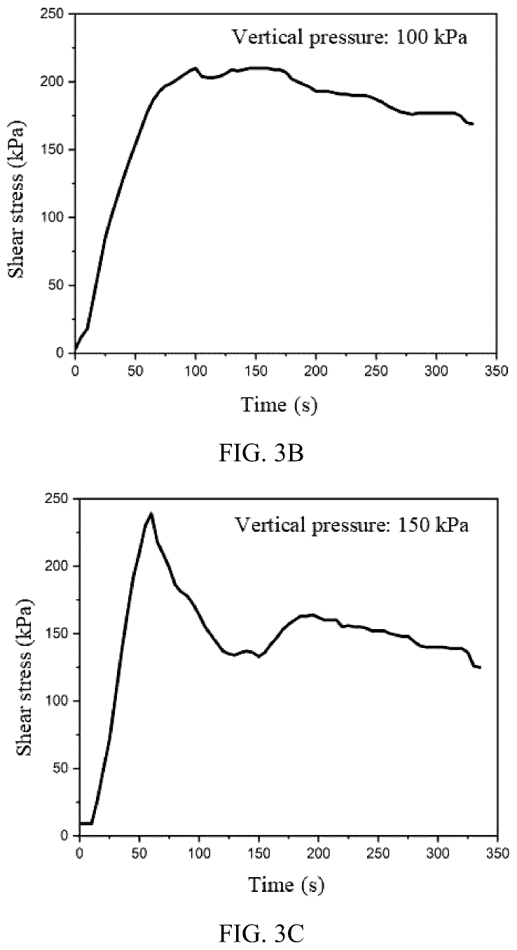

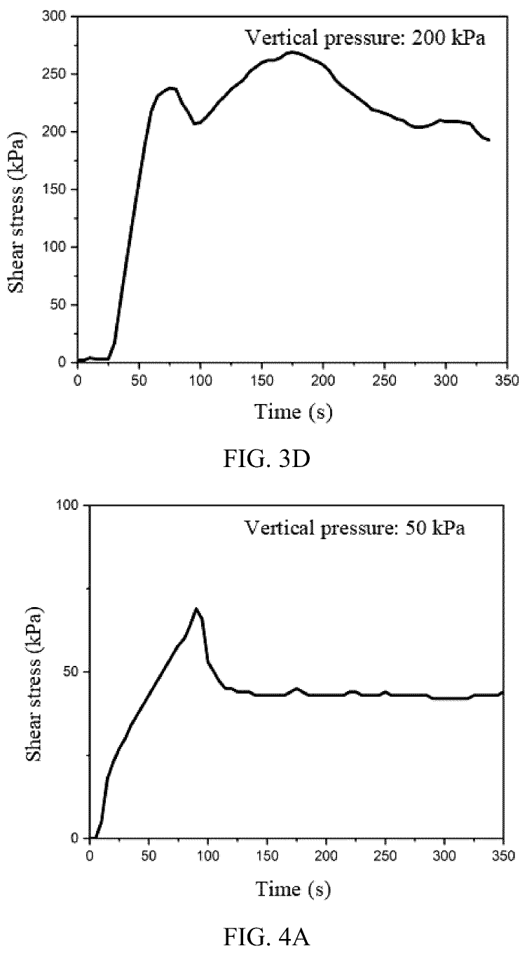

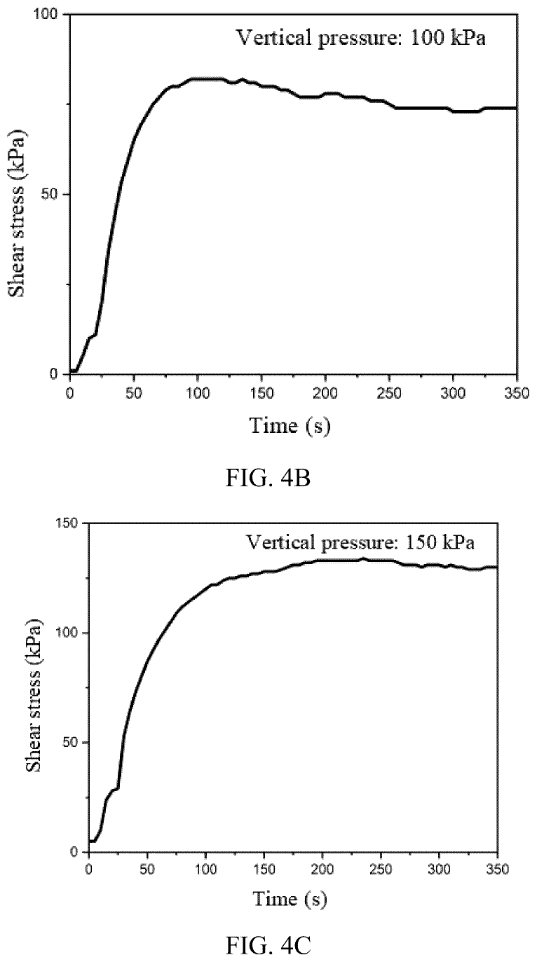

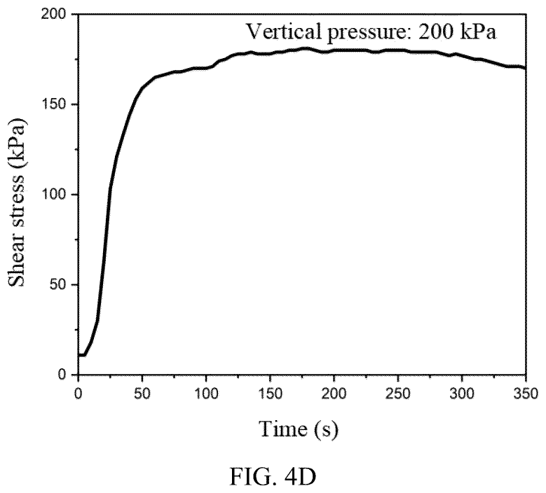

The reinforcement slurries for desertified soil prepared in Example 1 and Comparative Examples 1-6 were mixed with desertified soil at a volume ratio of 1:5, and placed in a soil cutting ring and compacted. After being air-dried at room temperature for 7 days, the shear strength of the soil blocks was tested in a strain-controlled direct shear apparatus, with partial results shown in FIGS. 3A, 3B, 3C, 3D, 4A, 4B, 4C and 4D.

The cohesive force and internal friction angle of the sandy soil were calculated via Coulomb's Law by fitting the test results obtained from the strain-controlled direct shear apparatus. The results are presented in Table 1.

TABLE 1
Performance test results

| | | Bearing | Cohesion | Internal friction |
|---|---|---|---|---|
| Samples | | pressure/kPa | force/kPa | angle/° |
| Example 1 | | 588.5 | 170.5 | 25.3 |
| Comparative Example 1 | | — | 20 | 37.7 |
| Comparative Example 2 | | 376.2 | 105.2 | 27.7 |
| Comparative Example 3 | | 418.3 | 127.6 | 21.2 |
| Comparative Example 4 | | 525.3 | 157.1 | 25.1 |
| Comparative | (1) | 402.2 | 113.2 | 28.5 |
| Example 5 | (2) | 431.7 | 125.3 | 23.6 |
| Comparative | (1) | 476.9 | 155.3 | 30.2 |
| Example 6 | (2) | 501.2 | 161.6 | 33.7 |

The above examples only express a few embodiments of the present disclosure, and the description thereof is relatively specific and detailed, but is not to be construed as limiting the scope of the disclosure patent. It is to be pointed out that for those skilled in the art, several modifications and improvements can be made without departing from the concept of the present disclosure, which all fall within the scope of protection of the present disclosure. Therefore, the scope of protection of the patent of the present disclosure shall be subject to the appended claims.

1. A reinforcement slurry for desertified soil, comprising the following raw materials:
0.5 weight percent (wt. %) to 1 wt. % of xanthan gum, 0.05 wt. % to 0.2 wt. % of microcrystalline cellulose, 0.05 wt. % to 0.2 wt. % of chitosan, 0.2 wt. % to 0.5 wt. % of triethanolamine, 1 per mille (‰) to 5% volume by volume (v/v) of glycerol, and the balance of water.

2. The reinforcement slurry for desertified soil according to claim 1, wherein a mass ratio of the microcrystalline cellulose to the xanthan gum is 1:(5-10).

3. The reinforcement slurry for desertified soil according to claim 1, wherein a mass ratio of the chitosan to the xanthan gum is 1:(5-10).

4. The reinforcement slurry for desertified soil according to claim 1, wherein the reinforcement slurry for desertified soil comprises the following raw materials:
1 wt. % of xanthan gum, 0.1 wt. % of microcrystalline cellulose, 0.1 wt. % of chitosan, 0.5‰(v/v) of triethanolamine, 5‰ (v/v) of glycerol, and the balance of water.

5. A preparation method for the reinforcement slurry for desertified soil according to claim 1, comprising the steps of:
S1, dissolving xanthan gum in water, followed by heating and stirring for a period of time to obtain a solution A;
S2, sequentially adding triethanolamine and microcrystalline cellulose into the solution A, followed by heating and stirring for a period of time to obtain a solution B; and
S3, adding chitosan and glycerin into the solution B, followed by heating and stirring for a period of time; and cooling the mixed solution to obtain the reinforcement slurry for desertified soil.

6. A preparation method for the reinforcement slurry for desertified soil according to claim 2, comprising the steps of:
S1, dissolving xanthan gum in water, followed by heating and stirring for a period of time to obtain a solution A;
S2, sequentially adding triethanolamine and microcrystalline cellulose into the solution A, followed by heating and stirring for a period of time to obtain a solution B; and
S3, adding chitosan and glycerin into the solution B, followed by heating and stirring for a period of time; and cooling the mixed solution to obtain the reinforcement slurry for desertified soil.

7. A preparation method for the reinforcement slurry for desertified soil according to claim 3, comprising the steps of:
S1, dissolving xanthan gum in water, followed by heating and stirring for a period of time to obtain a solution A;
S2, sequentially adding triethanolamine and microcrystalline cellulose into the solution A, followed by heating and stirring for a period of time to obtain a solution B; and
S3, adding chitosan and glycerin into the solution B, followed by heating and stirring for a period of time; and cooling the mixed solution to obtain the reinforcement slurry for desertified soil.

8. A preparation method for the reinforcement slurry for desertified soil according to claim 4, comprising the steps of:
S1, dissolving xanthan gum in water, followed by heating and stirring for a period of time to obtain a solution A;
S2, sequentially adding triethanolamine and microcrystalline cellulose into the solution A, followed by heating and stirring for a period of time to obtain a solution B; and
S3, adding chitosan and glycerin into the solution B, followed by heating and stirring for a period of time; and cooling the mixed solution to obtain the reinforcement slurry for desertified soil.

9. The preparation method according to claim 5, wherein the heating temperature of S1 is 40 °C, the stirring speed is 600-1200 rpm, and the stirring time is 2 h.

10. The preparation method according to claim 5, wherein the heating temperature of S2 is 50 °C, the stirring speed is 600-1200 rpm, and the stirring time is 0.5 h.

11. The preparation method according to claim 6, wherein the heating temperature of S2 is 50 °C, the stirring speed is 600-1200 rpm, and the stirring time is 0.5 h.

12. The preparation method according to claim 7, wherein the heating temperature of S2 is 50 °C, the stirring speed is 600-1200 rpm, and the stirring time is 0.5 h.

13. The preparation method according to claim 8, wherein the heating temperature of S2 is 50 °C, the stirring speed is 600-1200 rpm, and the stirring time is 0.5 h.

14. The preparation method according to claim 5, wherein the heating temperature of S3 is 50 °C, the stirring speed is 300-800 rpm, and the stirring time is 0.5 h.

15. The preparation method according to claim 6, wherein the heating temperature of S3 is 50 °C, the stirring speed is 300-800 rpm, and the stirring time is 0.5 h.

16. The preparation method according to claim 7, wherein the heating temperature of S3 is 50 °C, the stirring speed is 300-800 rpm, and the stirring time is 0.5 h.

17. An application of the reinforcement slurry for desertified soil for reinforcing desertified soil, the reinforcement slurry for desertified soil being the reinforcement slurry for desertified soil according to claim 1.

18. An application of the reinforcement slurry for desertified soil for reinforcing desertified soil, the reinforcement slurry for desertified soil being prepared by the preparation method according to claim 5.

19. The application according to claim 17, comprising the method of:
mixing the reinforcement slurry for desertified soil and desertified soil evenly to obtain reinforcement desertified soil and realize desertified soil treatment.

20. The application according to claim 18, comprising the method of:
mixing the reinforcement slurry for desertified soil and desertified soil evenly to obtain reinforcement desertified soil and realize desertified soil treatment.
